(19) United States
(12) Patent Application Publication
(10) Pub. No.: US 2014/0169968 A1
(43) Pub. Date: Jun. 19, 2014

(54) COLLISION AVOIDANCE SYSTEM FOR A WIND TURBINE

(71) Applicant: GENERAL ELECTRIC COMPANY, Schenectady, NY (US)

(72) Inventors: Robert Arvin Hedeen, Clifton Park, NY (US); Michael John Wittbrodt, Niskayuna, NY (US)

(73) Assignee: GENERAL ELECTRIC COMPANY, Schenectady, NY (US)

(21) Appl. No.: 13/713,641

(22) Filed: Dec. 13, 2012

(51) Int. Cl. F03D 11/00

(52) U.S. Cl. CPC F03D 11/00
USPC 416/146 R

(57) ABSTRACT

A collision avoidance system and a wind turbine includes a tower, a rotor coupled to the tower and a nacelle coupled to the rotor such that at least one of the tower, the rotor and the nacelle include one or more acoustic retroreflectors. Particularly, the acoustic retroreflectors are designed to reflect acoustic waves corresponding to a designated frequency range back to a source of the acoustic waves.

### BACKGROUND

Embodiments of the present disclosure relate generally to collision avoidance systems, and more particularly to wind turbines with enhanced wildlife collision avoidance.

Renewable energy resources are being increasingly employed as cleaner, more reliable and cost-efficient alternatives to fossil fuels for supplying global energy requirements. Wind energy, in particular, has emerged as one of the most favored renewable energy resources on account of being plentiful, renewable, widely distributed and clean. Generally, wind energy may be harnessed by wind turbines that are designed to produce electrical energy in response to a wide spectrum of wind speeds. These wind turbines may be typically spread across a particular geographical region such that the wind passing over the region may cause blades associated with the wind turbines to rotate. The rotating blades cause a rotor of an associated generator to turn, thus generating electrical power.

Although use of wind turbines has resulted in emission-free power generation and increased fuel diversity, proliferation of wind turbines has negatively affected wildlife, such as birds and bats, in a vicinity of the wind turbines. Bats, for example, are known to forage frequently over both open meadowlands, where larger turbines are likely to be located and over urban areas, which typically house microturbines, due to availability of roosting and foraging sites. Presence of wind turbines in both open and urban areas, thus, has resulted in increased interaction between the bats and the wind turbines.

Typically, bats are echolocating animals that emit acoustic signals and use corresponding echoes to identify and locate objects in an environment. However, echolocation signals emitted by the bats often undergo specular reflection from a surface of a turbine blade and are scattered in a plurality of directions. Thus, only a portion of the reflected signals may reach the bat, while a remaining portion of the reflected signals may be scattered in a plurality of directions. Accordingly, the reflected echolocation signals may fail to provide the bat with a realistic estimate of a size and location of the wind turbine. Such inefficient reflection of the echolocation signals may lead to a collision of the bat with one or more components of the wind turbine.

Generally, efforts to prevent interactions between bats and the wind turbine have focused on risk avoidance and impact mitigation. Risk avoidance, for example, entails conducting surveys prior to construction of the wind turbine to identify and avoid areas with high level of usage by bats. Further, impact mitigation may involve use of deterrent devices or a change in operation of the wind turbine. By way of example, in certain regions, government regulations mandate curtailing operations at specific times, such as during migration season or use of specific rotation speeds. Such restrictions, in turn, curtail power generation operations, which can result in significant economic losses to a wind turbine operator.

Certain other conventional collision avoidance approaches entail the use of electronic devices that actively emit ultrasonic signals that interfere with the echolocation signals. Such active electronic devices, however, not only deter bats, but may also displace the bats from their natural habitat. Additionally, such active deterrent devices are expensive, require external power and degrade upon exposure to environmental elements. Moreover, bats may change their echolocation properties adaptively based on changing conditions, thus rendering the active devices ineffective.

Accordingly, a cost-effective system that provides efficient wildlife collision avoidance without disrupting the natural habitat of the bats or the wind turbine operations is desirable.

### BRIEF DESCRIPTION

In accordance with an exemplary aspect of the present disclosure, a collision avoidance system is presented. The collision avoidance system includes a support and a rotor coupled to the support such that at least one of the support and the rotor incorporate one or more passive retroreflectors. Particularly, the passive retroreflectors are designed to reflect acoustic waves corresponding to a designated frequency range back to a source of the acoustic waves in a non-random pattern.

In accordance with another aspect of the present disclosure, a wind turbine is disclosed. The wind turbine includes a tower, a rotor coupled to the tower and a nacelle coupled to the rotor. Further, at least one of the tower, the rotor and the nacelle include one or more acoustic retroreflectors designed to reflect acoustic waves corresponding to a designated frequency range back to a source of the acoustic waves.

### DRAWINGS

These and other features, and aspects of embodiments of the present disclosure will become better understood when the following detailed description is read with reference to the accompanying drawings in which like characters represent like parts throughout the drawings, wherein:

FIG. 1 a perspective view of an exemplary wind turbine system configured for enhanced wildlife collision avoidance, in accordance with aspects of the present disclosure;

FIG. 2 is a schematic representation of an exemplary acoustic retroreflector for use in a wind turbine, in accordance with aspects of the present disclosure;

FIG. 3 is a schematic representation of an exemplary acoustic retroreflector including a trihedral arrangement of three reflective flat plates, in accordance with aspects of present disclosure;

FIG. 4 is a schematic representation of an exemplary retroreflection of echolocation signals from a wind turbine, in accordance with aspects of the present disclosure;

FIG. 5 is an exemplary configuration of an array of acoustic retroreflectors having a plurality of sizes, in accordance with aspects of the present disclosure;

FIG. 6 is an exemplary arrangement of acoustic retroreflectors clustered as a hexagonal retroreflector unit, in accordance with aspects of the present disclosure; and

FIG. 7 is a graphical representation of exemplary reflections produced using a flat plate reflector and a hexagonal retroreflector, in accordance with aspects of the present disclosure;

FIG. 8 is a graphical representation depicting the sensitivity to variations in the angle of incidence of acoustic waves for exemplary reflections produced using a flat plate reflector;

FIG. 9 is a graphical representation depicting the sensitivity to variations in the angle of incidence of acoustic waves for exemplary acoustic retroreflections produced using a hexagonal retroreflector, in accordance with aspects of the present disclosure; and

FIG. 10 is a schematic representation of a blade of a wind turbine including an acoustic retroreflector retrofit to the blade, in accordance with aspects of the present disclosure.

### DETAILED DESCRIPTION

The following description presents exemplary embodiments of a wind turbine system with enhanced wildlife collision avoidance capabilities. Particularly, embodiments illustrated hereinafter disclose a system that includes one or more passive acoustic retroreflection devices for mitigating collisions by echolocating animals such as bats with wind turbines. As used herein, the term “passive retroreflectors” corresponds to acoustic retroreflectors that reflect acoustic signals of specific frequencies based on their geometrical properties and without use of an external source of power.

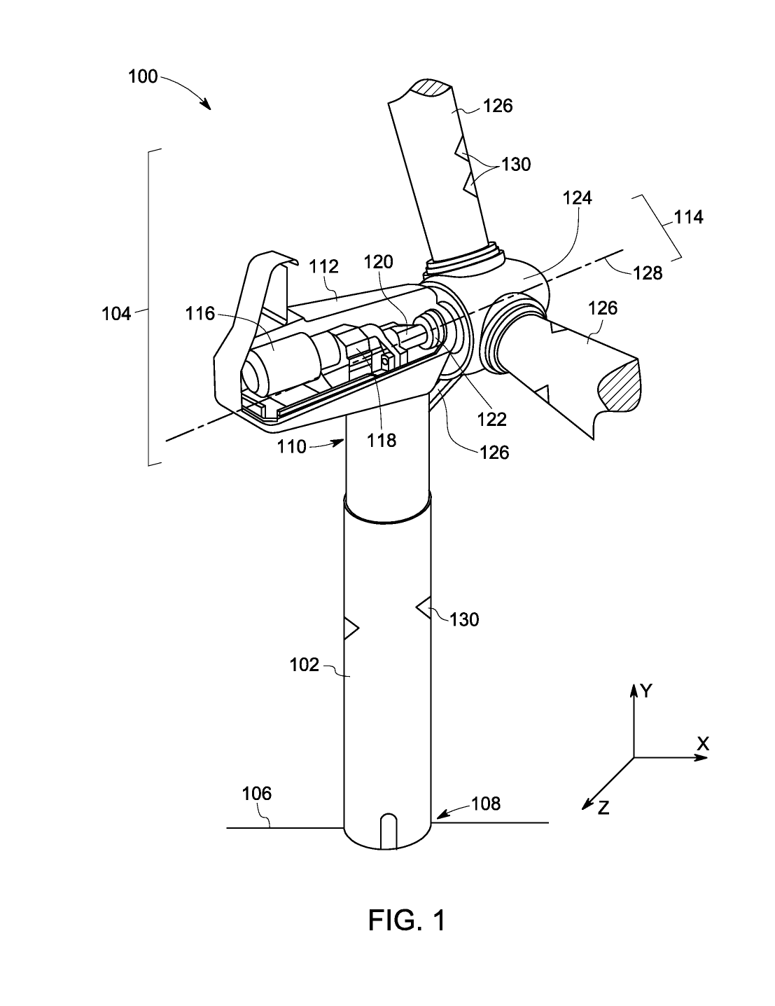

Although exemplary embodiments of the present system are described in the context of a wind turbine, it will be appreciated that use of the embodiments of the present system in various other contexts is also contemplated. By way of example, certain embodiments of the present disclosure may be employed in underwater systems for preventing collisions by underwater animals with components of the underwater systems such as water turbine impellers. An exemplary environment that is suitable for practicing various implementations of the present system is discussed in the following sections with reference to FIG. 1.

Specifically, FIG. 1 illustrates a perspective view of an exemplary wind turbine system 100 to provide enhanced wildlife collision avoidance, in accordance with certain aspects of the present disclosure. Generally, the wind turbine 100 is configured to convert kinetic energy of wind passing across the wind turbine 100 into electrical energy. To that end, the wind turbine 100 may include a plurality of mechanical moving parts configured to convert the kinetic energy of the wind into mechanical energy, which in turn, may be used to generate electricity.

By way of example, in one embodiment, the wind turbine 100 may include a tower 102 and a power unit 104 configured to generate electricity. In certain embodiments, the tower 102 may operate to elevate the power unit 104 to a height above a designated ground or sea level at which fast moving wind passes across the wind turbine 100. To that end, the tower 102 may include a structural beam that is disposed, for example, substantially perpendicular to a base or foundation 106 of the wind turbine 100. In one example, the tower 102 may be a cantilevered tower having a first end 108 rigidly coupled to a base or foundation 106 and a free or unsupported second end 110 configured to support a load presented by the power unit 104.

In certain embodiments, the power unit 104 may include one or more sub-units such as a nacelle 112 and a rotor 114. The rotor 114 may be operatively coupled to a rotary shaft 120 in the nacelle 112, for example, via a bearing assembly 122. Moreover, the rotor 114 may include a central hub 124 and a plurality of blades 126 that project outwards from the central hub 124 at circumferentially distributed locations. Although the exemplary embodiment of the wind turbine 100 illustrated in FIG. 1 depicts the central hub 124 as including three blades, in other embodiments, the central hub 124 may include a fewer or a greater number of blades 126.

Further, the blades 126 may be configured to interact with passing airflow to produce a lift that causes the central hub 124 to rotate about a longitudinal axis 128, thus converting the kinetic energy of the wind into mechanical energy. The mechanical energy generated by the blades 126 of the rotor 114 may further be converted to electrical energy by a generator 116 housed in the nacelle 112. It may be noted that only a few components of the wind turbine 100 are described with reference to FIG. 1. However, the wind turbine 100 may also include other components such as a step-up gearbox 118 to increase rotation speed, a yaw mechanism (not shown) to track the wind direction, braking mechanisms (not shown) to stop the wind turbine 100 and a cooling unit (not shown) to cool the gearbox and the generator during operation.

Generally, multiple wind turbines, such as the wind turbine 100 of FIG. 1, may be grouped to form a wind farm, which may be further coupled to a power grid (not shown) via one or more transmission lines (not shown). The transmission lines allow for transmission of the generated power to designated loads, for example, including customers of electrical utilities. To that end, the plurality of wind turbines may be dispersed across a wide geographical region. For example, large utility-scale turbines may be installed in forested ridge tops, meadows, grasslands, agricultural land or deserts, whereas microturbines may be installed in certain urban areas.

Accordingly, the wind turbine 100 includes one or more acoustic retroreflectors 130 to prevent or reduce collisions by wildlife with the wind turbine 100. Particularly, in one embodiment, the acoustic retroreflectors 130 may be disposed on the wind turbine 100 to significantly enhance reflection of the echolocation signals from the surface of one or more components of the wind turbine 100. Although the acoustic retroreflectors 130 are shown as being disposed on the blades 126 and the tower 102, they may instead or additionally be mounted on other components, such as the nacelle 112, where a possibility of collision of the bats is estimated to be high.

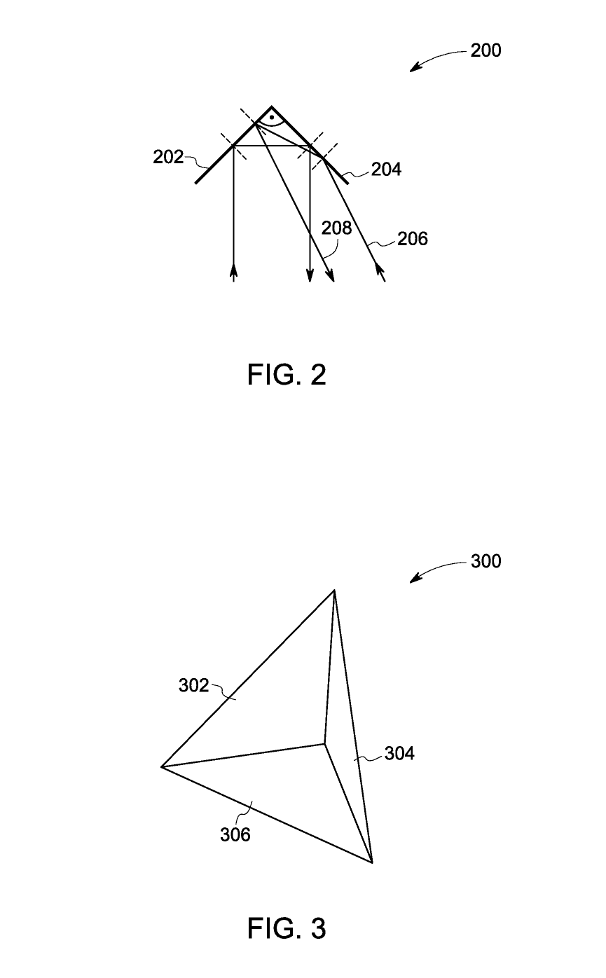

Further, in one embodiment, the size, shape, number and spatial distribution of the acoustic retroreflectors 130 may be selected based on the known behavior of specific species of bats that are typically known to use regions near the wind turbine 100. Certain structural and functional aspects of the acoustic retroreflectors 130 are described in greater detail with reference to FIGS. 2-6.

FIG. 2 illustrates a schematic representation of an exemplary acoustic retroreflector 200 for use in a wind turbine, such as the wind turbine 100 of FIG. 1. In a presently contemplated embodiment, such as illustrated in FIG. 2, the acoustic retroreflector 200 may be a corner reflector that includes, for example, a dihedral or a trihedral arrangement of two or more reflective flat plates 202 and 204 that may be arranged as mutually perpendicular and intersecting flat surfaces.

In one embodiment, acoustic waves such as echolocation signals 206 may be reflected from the mutually perpendicular flat plates 202 and 204 such that the reflected echolocation signals 208 travel along a plane parallel to the incoming echolocation signals 206. Particularly, the echolocation signals 208 are reflected such that they are concentrated in the direction of the echolocation source, such as a bat. The concentration of the reflected echolocation signals 208 prevents scattering, thereby maximizing the intensity of the reflected echolocation signals 208 that reaches the echolocation source to aid in accurate interpretation of a distance to the wind turbine. Although the embodiment of the acoustic retroreflector 200 illustrated in FIG. 2 depicts only two reflective flat plates 202 and 204, in certain other embodiments, the acoustic retroreflector 200 may include more than two reflective flat plates.

FIG. 3, for example, illustrates an acoustic retroreflector 300 including a trihedral arrangement of three reflective flat plates 302, 304 and 306. In one embodiment, the reflective flat plates 302, 304 and 306 are arranged in a mutually perpendicular orientation representative of a corner of a cube. When acoustic waves (not shown in FIG. 3) such as echolocation signals are incident on the reflective flat plates 302, 304 and 306, the acoustic waves may undergo a total internal reflection off the orthogonally positioned reflective flat plates 302, 304 and 306 to emerge in an opposite direction, parallel to the incident acoustic wave. However, unlike the reflection of the echolocation signals from a dihedral retroreflector (such as the acoustic retroreflector 200 of FIG. 2), along a plane parallel to the incoming echolocation signals, the acoustic waves are reflected off the trihedral acoustic retroreflector 300 in a single line parallel to the incident acoustic waves. The acoustic retroreflector 300, thus, may be configured to reflect acoustic waves, such as echolocating signals back towards a source, for example a bat, in a more focused beam rather than being dispersed as specular reflection.

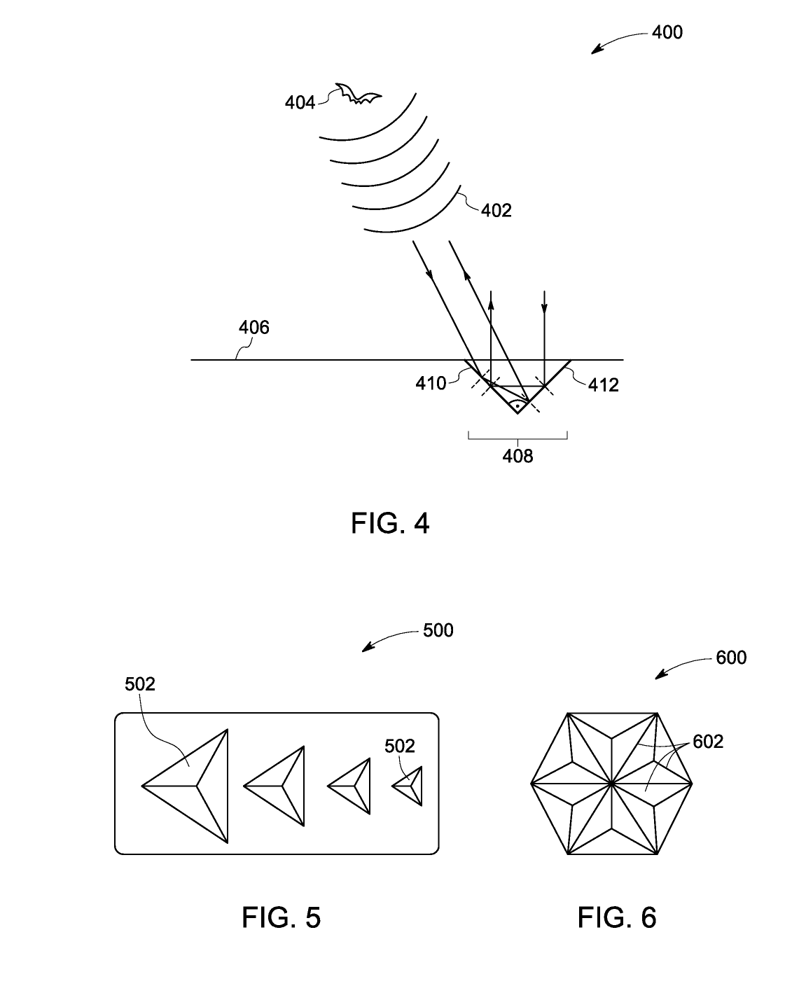

Further, FIG. 4 illustrates a schematic representation 400 of an exemplary retroreflection of echolocation signals 402 emitted by a bat 404 from a blade 406 of a wind turbine, such as the wind turbine 100 of FIG. 1. To that end, the wind turbine may include an acoustic retroreflector 408, for example, embedded in the blade 406 of the wind turbine. Particularly, in the embodiment illustrated in FIG. 4, the acoustic retroreflector 408 is depicted as a 90-degree trihedral embedded in the surface of the blade 406 such that an internal or concave face of the acoustic retroreflector 408 is positioned outwards towards a source of the acoustic wave, for example, the bat 404. Further, the acoustic retroreflector 408 is depicted such that a plane corresponding to a top of the acoustic retroreflector 408 is normal to the surface of the blade 406. Such a configuration of the acoustic retroreflector 408 may aid in improving reflection of the echolocation signals and minimizing airflow properties of the wind turbine.

In an alternative embodiment, however, a dihedral or a trihedral-shaped depression of a particular size may be sculpted or impressed in a surface of the blade 406 to form the acoustic retroreflector 408. In certain further embodiments, the acoustic retroreflector 408 may include solid reflectors mechanically attached to the surface of the blade 406, for example, using glue or mechanical fasteners such as screws.

In a presently contemplated embodiment, the acoustic retroreflector 408 may be associated with the wind turbine such that the echolocation signals 402 are incident on a first surface 410 of the acoustic retroreflector 408. The trihedral arrangement of the acoustic retroreflector 408 causes the echolocation signals 402 incident on the first surface 410 to be reflected off a second surface 412 and a third surface (not shown in FIG. 4) to emerge in a direction parallel and opposite to the incident echolocation signal 402. Reflection of a significant portion of the echolocation signal 402 back to the bat 404 may allow the bat 404 to estimate the size of the wind turbine and distance to the wind turbine more accurately and in a longer response time, thus helping to avoid collisions.

In certain embodiments, reflection of the echolocation signal 402 may be further enhanced by using a hard non-porous material on the surface of the acoustic retroreflector 408 that reflects sound waves without significantly absorbing the incident acoustic energy. To that end, in one embodiment, the acoustic retroreflector 408 may include a material, such as aluminum or fiber-reinforced epoxy (FRP) having a reflection coefficient of at least 0.7. Further, in certain embodiments, the acoustic retroreflector 408 may be coated with an acoustically transparent material such as Mylar. In certain other embodiments, however, the material of the acoustic retroreflector 408 may be the same as the material of the blade 406 to preserve the structural integrity or aerodynamic properties of the blade 406.

Additionally, in accordance with certain aspects of the present disclosure, one or more geometrical properties of the acoustic retroreflector 408 may be selected such that the bats are able to identify the reflected acoustic waves as being different from naturally occurring reflections from trees and prey. By way of example, these properties may include size, shape, depth, orientation, location and spatial distribution of the acoustic retroreflector 408 over a surface of the wind turbine. Particularly, the geometrical properties of the acoustic retroreflector 408 may be selected to maximize reflection efficiency in specific frequency ranges, while at the same time minimizing the negative airflow impact to the turbine blade. In one embodiment, the frequency ranges may be chosen to coincide with the echolocation signals of a target bat species.

Further, FIGS. 5-6 illustrate certain exemplary geometrical configurations of the acoustic retroreflectors for use in enhanced wildlife collision avoidance. Particularly, FIG. 5 illustrates an exemplary configuration of an array 500 of retroreflectors having a plurality of sizes. In certain embodiments, the size of an individual acoustic retroreflector unit 502 may be chosen such that the reflected acoustic signals may have a sufficiently large wavelength that may be easily detected by a target species of an echolocating source, such as a bat. To that end, in one embodiment, the size of the acoustic retroreflector unit 502 may be selected, for example, to be at least a factor of ten wavelengths greater than the targeted echolocation signal of the bat. Accordingly, for retroreflecting a typical echolocating frequency of about 50 kHz and an acoustic wavelength of 7 millimeters used by certain bat species, the acoustic retroreflector unit 502 may be designed to have a side of at least 70 mm, or about 2.5 inches.

In FIG. 5, the array 500 of retroreflectors includes individual acoustic retroreflector units 502 arranged in order of increasing (or decreasing) size. In other embodiments, however, the acoustic retroreflector units 502 of different sizes may be arranged in certain determined patterns designed to match the echolocation frequencies of different bat species that may be expected to use areas surrounding the site of the wind turbine. Alternatively, acoustic retroreflector units 502 of the same size may be clustered to form a target for reflecting the echolocation signals having longer wavelengths so as to be detected by the bats from a greater distance.

FIG. 6, for example, illustrates an exemplary arrangement of acoustic retroreflectors clustered as a hexagonal retroreflector unit 600. Particularly, in one embodiment, the hexagonal retroreflector unit 600 may include a group of trihedral retroreflectors 602. The geometric properties of the trihedral retroreflectors 602 allows them to tile naturally in groups of six to form the hexagonal retroreflector unit 600 and provide a larger surface area for improved detection and retroreflection of echolocation signals, while preserving the aerodynamic properties of the turbine blades. Particularly, geometrical properties of the clustered trihedral retroreflectors 602 may lead to reflection of the echolocation signals at higher amplitudes and greater signal strength. The reflection of the echolocation signals at higher amplitudes results in an increased range of the echolocation signals, which in turn, may provide a longer response time for the bats to avoid collisions with obstructions.

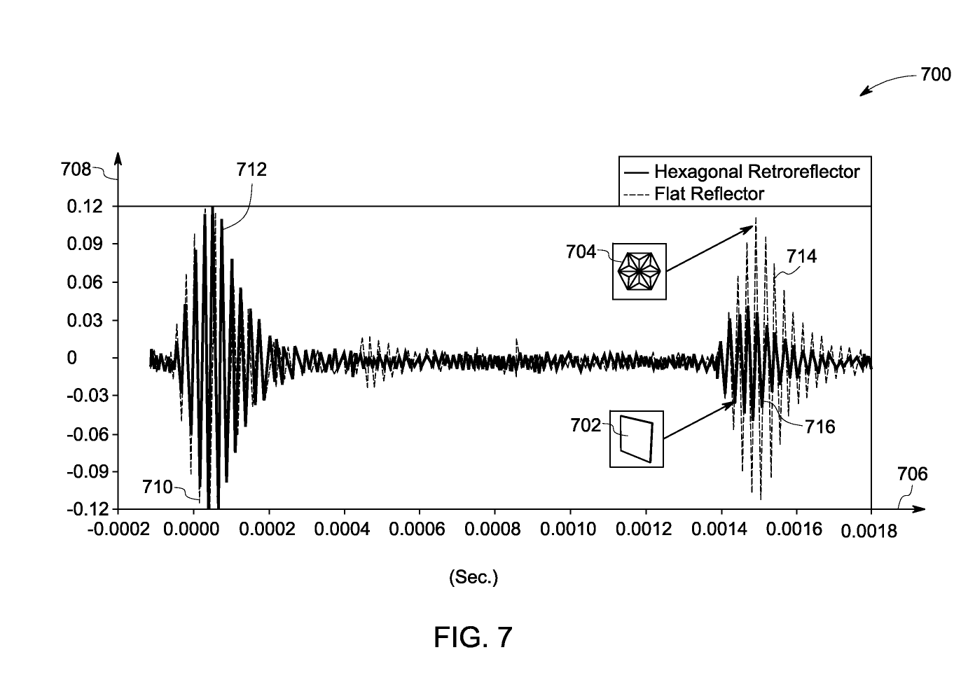

FIGS. 7, 8 and 9 illustrate graphical representations 700, 800, and 900, respectively, of exemplary acoustic waves and their reflections from a conventional flat plate 702 and a hexagonal retroreflector 704, in accordance with embodiments of the present disclosure. During exemplary implementations, a plurality of time and frequency combinations of ultrasonic pulses representative of a targeted echolocation signal were measured. Particularly, the time and frequency values corresponding to the echolocation signal were measured following emission and reflection from the flat reflector 702 and the hexagonal retroreflector 704. Additionally, amplitude and phase of the emitted and reflected echolocation signal were determined from the measured time and frequency values. The determined values were then used to generate the graphical representations 700, 800, and 900, where amplitude of the echolocation signal is represented along an X-axis 706, and time is represented along a Y-axis 708. The effectiveness of reflection of the echolocation signal using the flat reflector 702 and the hexagonal retroreflector 704 may then be determined, for example, by comparing corresponding emitted and reflected echolocation signals.

Particularly, FIG. 7 is a graphical representation 700 showing a comparison between an acoustic pulse reflected from the conventional flat plate reflector 702 and the hexagonal retroreflector 704. In FIG. 7, reference numeral 710 is representative of a 40-kilohertz (kHz) pulse emitted towards the flat plate reflector 702, whereas reference numeral 712 is representative of a 40 kHz pulse emitted towards the hexagonal retroreflector 704. Further, reference numeral 714 is representative of a 40 kHz pulse that reflected off the flat plate reflector 702, whereas reference numeral 716 is representative of a 40 kHz pulse that reflected off the hexagonal retroreflector 704. As illustrated in the graphical representation 700, the pulse 716 that reflected off the hexagonal retroreflector 704 provided about a 10-decibel (dB) gain over the pulse 714 that reflected off the flat plate reflector 702. Use of the hexagonal retroreflector 704, thus, may result in higher visibility of obstructions to echolocating wildlife as compared to the flat plate reflector 702 or an unmodified surface of the turbine blades.

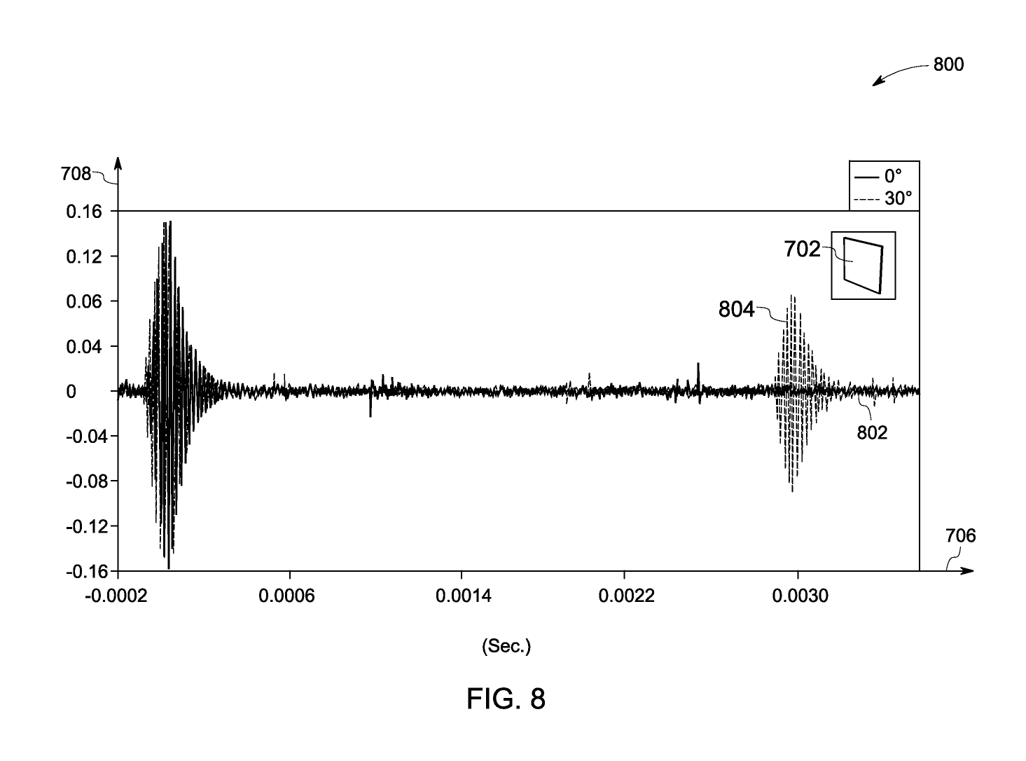

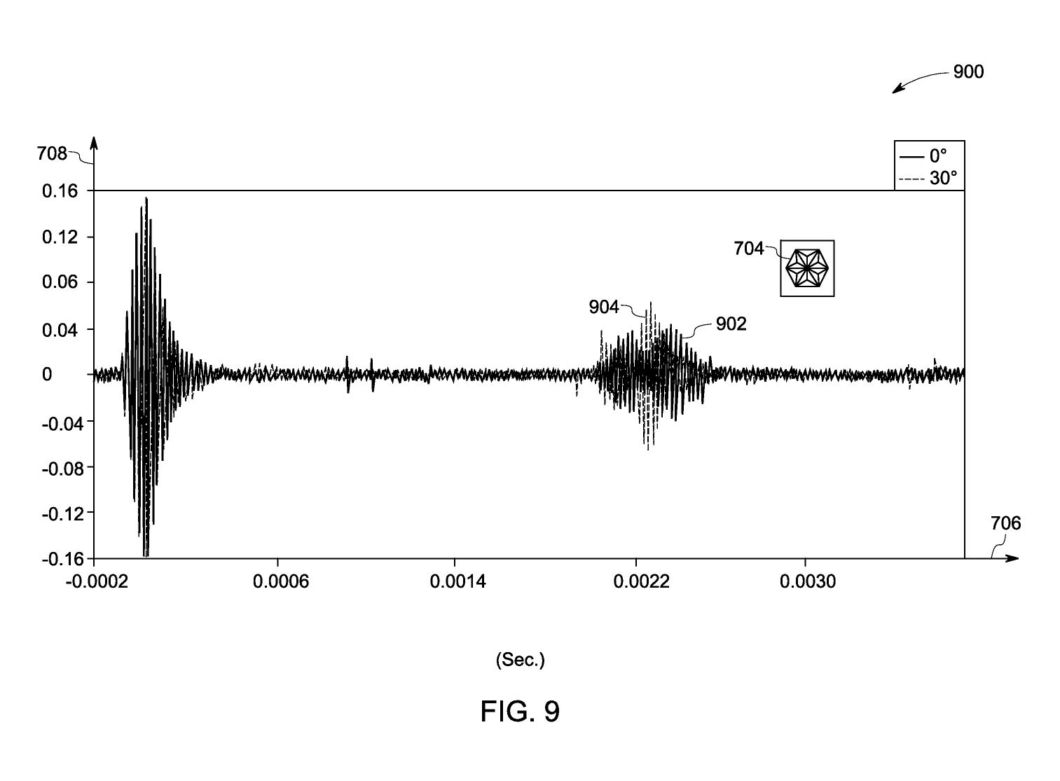

FIGS. 8 and 9 are graphical illustrations depicting the sensitivity to variations in the angle of incidence of acoustic waves for a flat plate reflector and a hexagonal retroreflector. More specifically, FIG. 8 illustrates the graphical representation 800 depicting a pulse 802 corresponding to an echolocation signal that reflected off the flat plate reflector 702 when an angle of incidence of the echolocation signal on the flat plate reflector 702 was about zero degrees. The graphical representation 800 also depicts a pulse 804 corresponding to an echolocation signal that reflected off the flat plate reflector 702 in a specular manner, when an angle of incidence of the echolocation signal on the flat reflector 702 was about thirty degrees. As illustrated in the graphical representation 800, the pulse 804 that reflected off the flat reflector 702 aligned at an angle of incidence of about thirty degrees is substantially smaller than a pulse 802 that reflected off the flat reflector 702 aligned at an angle of zero degrees. Accordingly, the planar surface of a conventional wind turbine blade may prove to be a poor reflector of the echolocation signals, thus resulting in collision and injury to the bats.

Further, FIG. 9 illustrates the graphical representation 900 depicting an echolocation signal 902 that reflected off the hexagonal retroreflector 704 when an angle of incidence of the echolocation signal on the hexagonal retroreflector 704 was about zero degrees. Further, the graphical representation 900 also depicts an echolocation signal 904 that reflected off the hexagonal retroreflector 704 when the angle of incidence of the echolocation signal on the hexagonal retroreflector 704 was about thirty degrees. As illustrated in the graphical representation 900, the signal 904 that reflected from the hexagonal retroreflector 704 aligned at an angle of incidence of thirty degrees was substantially similar to the echolocation signal 902 that reflected off the hexagonal retroreflector 704 aligned at an angle of incidence of zero degrees. Use of the hexagonal retroreflector 704, thus, may provide consistent retroreflection performance irrespective of the angle of incidence of the echolocation signal on the hexagonal retroreflector 704.

In certain embodiments, in addition to the orientation, an appropriate shape, size, position and distribution of the acoustic retroreflectors on the wind turbine may also be selected based on certain behavioral attributes of bats such as roosting, foraging, hibernation and migratory patterns. The behavioral attributes, for example, may also include altitude or direction of flight, path of flight, rate of movement, rate of attraction or collision avoidance, location of attraction or collision avoidance and composition of species. In one embodiment, the behavioral attributes may be evaluated for determining the appropriate shape, size, position and distribution of the acoustic retroreflectors on the wind turbine that may allow retroreflection of echolocation frequencies corresponding to one or more targeted species of bats.

By way of example, if a target species of bats is known to forage at lower altitudes, the acoustic retroreflectors may be incorporated into the tower of the wind turbine at lower elevations. Similarly, the acoustic retroreflectors may be distributed along the surface of the wind turbine at determined distances to enhance a probability of incidence and retroreflection of the echolocation signals. In one embodiment, for example, the acoustic retroreflectors may be disposed every ten inches along the length of a turbine blade to aid in retroreflection of the echolocation signals with greater signal strength in a pattern that may be interpreted by the bats as an obstruction. Generally, the acoustic retroreflectors may be distributed evenly or further apart, or grouped in clusters of two or more at a wider separation over different parts of the wind turbine to allow the bats to distinguish the wind turbine from naturally occurring reflectors in the environment. To that end, in one embodiment, the acoustic retroreflectors may be distributed with regularity and repetition over the surface of the wind turbine such that the bats interpret the resulting regular and repetitive reflection of the acoustic waves as an obstruction different from the natural reflectors that are typically randomly distributed.

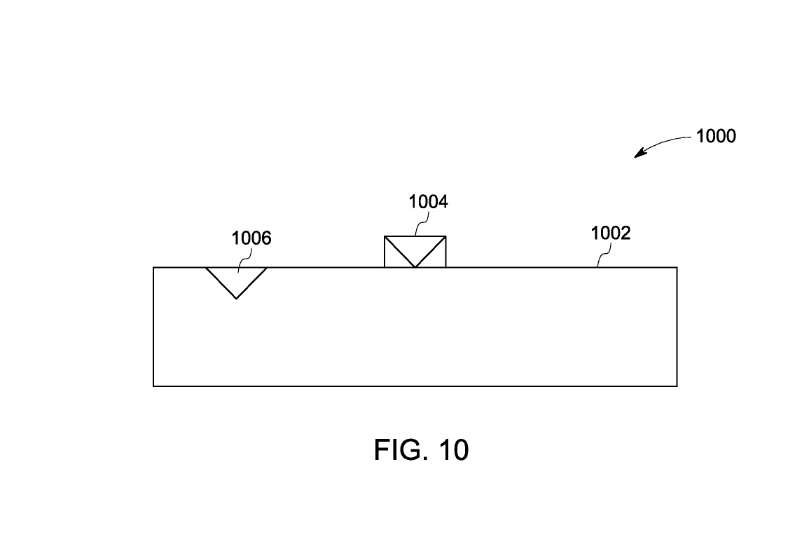

Use of the acoustic retroreflectors in accordance with exemplary aspects of the present disclosure, thus, provide an efficient technique for enhancing the reflection of acoustic signals back to the bats to aid in better echolocation. Particularly, use of the passive acoustic retroreflectors, such as described herein above, obviate use of external power sources and may be retrofit to existing wind turbines. FIG. 10, for example, is a schematic representation 1000 of a conventional blade 1002 of a wind turbine including an acoustic retroreflector 1004 retrofit to the blade 1002 through external coupling. In certain embodiments, the blade 1002 may include the externally coupled acoustic retroreflector 1004 in addition to or in lieu of an embedded acoustic retroreflector 1006. The passive acoustic retroreflectors, thus, may provide a cost-effective solution for collision avoidance without disrupting the behavior or habitat of the bats and without compromising on the structural integrity or aerodynamic properties of the wind turbine.

Further, the acoustic retroreflectors may provide enhanced echolocation by allowing customization of a shape, size, location and spatial distribution of the acoustic retroreflectors based on specific echolocation frequencies of targeted bat species. Particularly, by allowing for a reflection of the echolocation signal at higher amplitudes, the acoustic retroreflectors may provide bats with a longer response time, thus, preventing collisions that may result in injury to bats. Accordingly, use of the acoustic retroreflectors may aid in preserving endangered species of bats and biological diversity in regions surrounding the wind turbines.

Although embodiments of the present system are described with reference to a wind turbine, the present system may also be used in certain other structures such as meteorological towers or marine systems for enhanced collision avoidance. By way of example, acoustic retroreflectors such as the acoustic retroreflectors 400, 506 or 602 of FIGS. 4, 5 and 6, respectively, may be disposed on underwater impellers of a water turbine for preventing collision with echolocating marine animals such as dolphins and whales. To that end, as previously noted, the acoustic retroreflectors may be tuned or customized to reflect targeted echolocation signals corresponding to a designated frequency range received from the echolocating animal.

It may be noted that although specific features of various embodiments of the present systems may be shown in or described with respect to only certain drawings and not in others, this is for convenience only. It is to be understood that the described features, structures, or characteristics may be combined or used interchangeably in any suitable manner in the various embodiments, for example, to construct additional assemblies and techniques for enhanced collision avoidance.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A wind turbine, comprising:
a tower;
a rotor coupled to the tower; and
a nacelle coupled to the rotor, wherein at least one of the tower, the rotor and the nacelle comprise one or more acoustic retroreflectors designed to reflect acoustic waves corresponding to a designated frequency range back to a source of the acoustic waves.

2. The wind turbine of claim 1, wherein a shape of the one or more acoustic retroreflectors comprises a dihedral.

3. The wind turbine of claim 1, wherein a shape of the one or more acoustic retroreflectors comprises a trihedral.

4. The wind turbine of claim 1, wherein a size of the one or more acoustic retroreflectors is at least ten times greater than a wavelength of the acoustic waves corresponding to the designated frequency range.

5. The wind turbine of claim 1, wherein the one or more acoustic retroreflectors are embedded in the tower, the rotor, the nacelle, or combinations thereof.

6. The wind turbine of claim 5, wherein a material composition of the one or more acoustic retroreflectors is the same as a material composition of the tower, the rotor or the nacelle within which the one or more acoustic retroreflectors are embedded.

7. The wind turbine of claim 5, wherein the one or more acoustic retroreflectors comprise a material having a reflection coefficient of at least 0.7.

8. The wind turbine of claim 5, wherein a number of the one or more acoustic retroreflectors embedded in the tower, the rotor, the nacelle, or combinations thereof, is based on the designated frequency range.

9. The wind turbine of claim 5, wherein a spatial distribution of the one or more acoustic retroreflectors embedded in the tower, the rotor, the nacelle, or combinations thereof, is based on a repetitive pattern.

10. The wind turbine of claim 1, wherein the acoustic waves correspond to echolocating signals.

11. A collision avoidance system, comprising:
a support; and
a rotor coupled to the support, wherein at least one of the support and the rotor incorporate one or more passive retroreflectors designed to reflect acoustic waves corresponding to a designated frequency range back to a source of the acoustic waves in a non-random pattern.

12. The system of claim 11, comprising a marine system.

13. The system of claim 11, wherein the one or more acoustic retroreflectors comprise a passive retroreflector.

14. The system of claim 11, wherein a shape of the one or more acoustic retroreflectors comprises a dihedral.

15. The system of claim 11, wherein a shape of the one or more acoustic retroreflectors comprises a trihedral.

16. The system of claim 11, wherein a size of the one or more acoustic retroreflectors is at least ten times greater than a wavelength of the acoustic waves corresponding to the designated frequency range.

17. The system of claim 11, wherein the one or more acoustic retroreflectors are embedded in the support, the rotor, or a combination thereof.

18. The system of claim 17, wherein a material composition of the one or more acoustic retroreflectors is the same as a material composition of the support, the rotor, or a combination thereof.

19. The system of claim 17, wherein a number of the one or more acoustic retroreflectors embedded in the support, the rotor, or a combination thereof, is based on the designated frequency range.

20. The system of claim 17, wherein a spatial distribution of the one or more acoustic retroreflectors embedded in the support, the rotor, or a combination thereof, is based on the designated frequency range.

21. The system of claim 11, wherein the one or more acoustic retroreflectors comprise a material having a reflection coefficient of at least 0.7.

22. The system claim 11, wherein the acoustic waves correspond to echolocating signals.
